(19) United States
(12) Patent Application Publication
(10) Pub. No.: US 2011/0206033 A1
(43) Pub. Date: Aug. 25, 2011

(54) COMMUNICATION METHOD BETWEEN WIRELESS NODES

(75) Inventors: Dong Hyun AHN, Daejeon (KR); Choongil Yeh, Daejeon (KR); DongSeung Kwon, Daejeon (KR); Kwang Jae Lim, Daejeon (KR); Jihyung Kim, Daejeon (KR); Young Seog Song, Daejeon (KR); Wooram Shin, Daejeon (KR)

(73) Assignee: Electronics and Telecommunications Research Institute, Daejeon (KR)

(21) Appl. No.: 13/032,129

(22) Filed: Feb. 22, 2011

(30) Foreign Application Priority Data
Feb. 22, 2010 (KR) 10-2010-0015512
Feb. 22, 2011 (KR) 10-2011-0015339

(51) Int. Cl. H04W 56/00

(52) U.S. Cl. 370/350

(57) ABSTRACT

In a wireless communication system, when a transmission node has data to be transmitted to a reception node, it checks an acknowledgement slot of the current communication frame and transmits information regarding a reception available acknowledgement slot to the reception node through a request-to-send (RTS) slot in the current communication frame, and the reception node transmits information regarding the data slot available for receiving among at least one data slot corresponding to the reception available acknowledgement slot to the transmission node through a clear-to-send (CTS) slot corresponding to the data request slot in the current communication frame. Thereafter, the transmission node transmits data to the reception node through a reservation data slot of the subsequent communication frame until the message transmission fails or finishes.

### CROSS-REFERENCE TO RELATED APPLICATION

This application claims priority to and the benefit of Korean Patent Application No. 10-2010-0015512 and 10-2011-0015339 filed in the Korean Intellectual Property Office on Feb. 22, 2010 and Feb. 22, 2011, the entire contents of which are incorporated herein by reference.

### BACKGROUND OF THE INVENTION

(a) Field of the Invention

The present invention relates to a communication method between wireless nodes and, more particularly, to channel controlling for communication between nodes without a coordinator managing a shared channel in a network in which neighbor nodes share a channel.

(b) Description of the Related Art

Carrier Sense Multiple Access with Collision Avoidance (CSMA/CA) is one of control schemes of a distributed wireless communication channel in a wireless communication network. According to the CSMA/CA scheme, a transmission side recognizes an occupancy state of one physical channel, and when the physical channel is idle, the transmission side transmits a relatively short request to send (RTS) message via the corresponding physical channel, and thereafter, when the transmission side normally receives a clear to send (CTS) message from the reception side, the transmission side occupies a physical channel of a certain section, whereby a channel is reserved before being used to thus prevent a possible packet collision.

However, the CSMA/CA scheme has a limitation in that the RTS/CTS messages are exchanged whenever a data transmission is requested, severely wasting channels, and when the density of wireless nodes is high in a certain space or when the request for communication traffic is increased, a stable performance cannot be obtained. In addition, when real time communication, like a VoIP service, is requested, quality of service (QoS) cannot be guaranteed.

A packet reserved multi-access scheme is another control scheme of a distributed wireless communication channel. According to the packet reserved multi-access scheme, in order to reserve a data channel, an occupancy state of the data channel is recognized, and when the data channel is idle, the data channel is arbitrarily used directly, thus having the authority to use the corresponding data channel.

However, in the packet reserved multi-access scheme, since a data channel is commonly used as a reserved channel, when communication traffic is increased, the system is easily reduced to become unstable.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a communication method between wireless nodes having advantages of providing a stable communication performance even when the density of wireless nodes is high or when communication traffic is increased.

An exemplary embodiment of the present invention provides a method for transmitting a message by a transmission node to a reception node in a wireless communication system in which communication nodes share the same frame structure and frame synchronization. The communication method includes: transmitting information regarding an occupancy state of an acknowledgement slot of the current communication frame to the reception node through a request-to-send (RTS) slot; receiving information regarding an occupancy state of a data slot corresponding to the acknowledgement slot from the reception node through a clear-to-send (CTS) slot corresponding to the RTS slot; when there is information regarding an available data slot upon receiving the CTS slot, securing the authority to use a data slot at a position corresponding to the information regarding the available data slot in the subsequent communication frame; transmitting a data packet to the reception node through the data slot secured to be used; and receiving an acknowledgement slot corresponding to the data slot from the reception node to confirming whether the data packet has been received.

The transmitting of the RTS slot to the reception node may include: including information regarding at least one of acknowledgement slots of a transmission node having a lower priority level than that of the transmission node, in a RTS packet in the current communication frame; marking a flag, which denotes priority, on the RTS packet; and transmitting the RTS packet to the reception node through the RTS slot.

The receiving of the CTS slot may include: transmitting a CTS packet through the CTS slot, wherein when the RTS packet includes a flag, which denotes priority, marked thereon, the CTS packet may include information regarding a data slot corresponding to the acknowledgement slot presented in the received RTS packet in the CTS packet.

The communication method may further include: when it is confirmed that transmission of the data slot, for which the authority to use is secured, is successfully completed upon receiving the acknowledgement slot, securing the authority to use a data slot at the same position corresponding to the information regarding the available data slot in the next subsequent frame; transmitting an additional data packet to the reception node through the data slot secured to be used in the subsequent frame; and receiving the acknowledgement slot corresponding to the data slot from the reception node to confirm whether the data packet has been received.

In the transmission of the additional data packet, the additional data packet may be transmitted through the data slot secured to be used up to the number of times corresponding to a determined number of continuous communication frames.

The transmission of the information regarding an occupancy state of an acknowledgement slot to the reception node through the RTS slot may include: checking an occupancy state of a plurality of acknowledgement slots in the current communication frame and selecting at least one empty acknowledgement slot; and transmitting information regarding the at least one empty acknowledgement slot through the RTS slot.

The transmitting of the information regarding the at least one empty acknowledgement slot through the RTS slot may include: including information regarding the at least one empty acknowledgement slot in the RTS packet and transmitting the same through the RTS slot.

Another embodiment of the present invention provides a method for receiving a data message by a reception node from a transmission node in a wireless communication system in which communication nodes share the same frame structure and frame synchronization. The communication method includes: receiving, from the transmission node, information regarding an occupancy state of an acknowledgement slot of the transmission node through a request-to-send (RTS) slot in the current communication frame; transmitting information regarding an occupancy state of the data slot corresponding to an unoccupied acknowledgement slot from the information regarding the occupancy state of the acknowledgement slot to the transmission node through a clear-to-send (CTS) slot; receiving the data slot at the corresponding position with reference to the position of an unoccupied data slot in the subsequent frame; and transmitting reception results of the data slot to the transmission node through an acknowledgement slot corresponding to the received data slot.

The receiving of the information regarding an occupancy state of a reception acknowledge slot through the RTS slot may include: receiving a RTS packet with a flag, which denotes priority, marked thereon, wherein the RTS packet includes information regarding at least one of acknowledgement slots of a transmission node having a lower priority level than that of the transmission node in the current communication frame.

The transmitting of the information regarding an occupancy state of the data slot through the CTS slot may include: when a flag, which denotes priority, is marked on a received RTS packet, including information regarding a data slot corresponding to an acknowledgement slot presented in the received RTS packet, in a CTS packet; and transmitting the CTS packet through the CTS slot.

The receiving of the information regarding an occupancy state of an acknowledgement slot through the RTS slot may include: receiving information regarding at least one empty acknowledgement slot among a plurality of acknowledgement slots in the current communication frame through the RTS slot.

The transmitting of information regarding an occupancy state of a data slot through the CTS slot may include: transmitting information regarding at least one empty data slot in the current communication frame, among data slots corresponding to the at least one empty acknowledgement slot, through the CTS slot.

### BRIEF DESCRIPTION OF THE DRAWINGS

FIG. 1 is a view illustrating a wireless network according to an exemplary embodiment of the present invention.

FIG. 2 is a view illustrating a communication frame used for communication between nodes according to an exemplary embodiment of the present invention.

FIG. 3 is a flowchart illustrating the process of a method for transmitting and receiving messages between nodes according to a first exemplary embodiment of the present invention.

FIG. 4 is a flowchart illustrating the process of a method for transmitting a message by a node according to a second exemplary embodiment of the present invention.

FIG. 5 is a schematic block diagram of a communication apparatus of a node according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising”, will be understood to imply the inclusion of stated elements but not the exclusion of any other elements.

A method for communication between wireless nodes according to an exemplary embodiment of the present invention will now be described in detail with reference to the accompanying drawings.

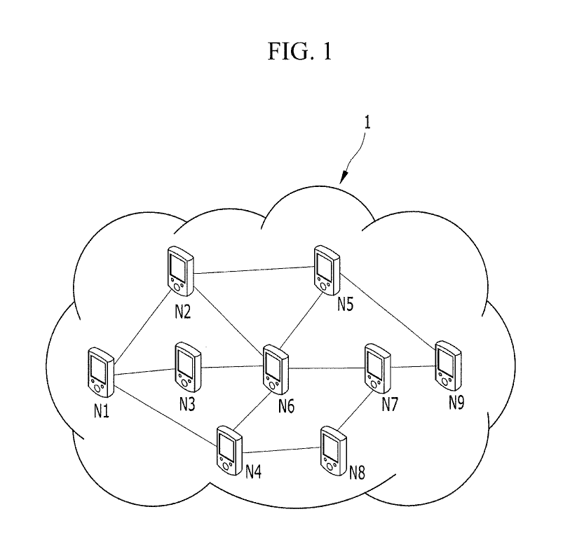

FIG. 1 is a view illustrating a wireless network according to an exemplary embodiment of the present invention.

In FIG. 1 an ad-hoc network 1 is illustrated as a wireless network according to an exemplary embodiment of the present invention, in which nodes N1 to N9 according to an exemplary embodiment of the present invention communicate in a multi-hop manner.

With reference to FIG. 1, the ad-hoc network 1 may include a plurality of nodes N1 to N9.

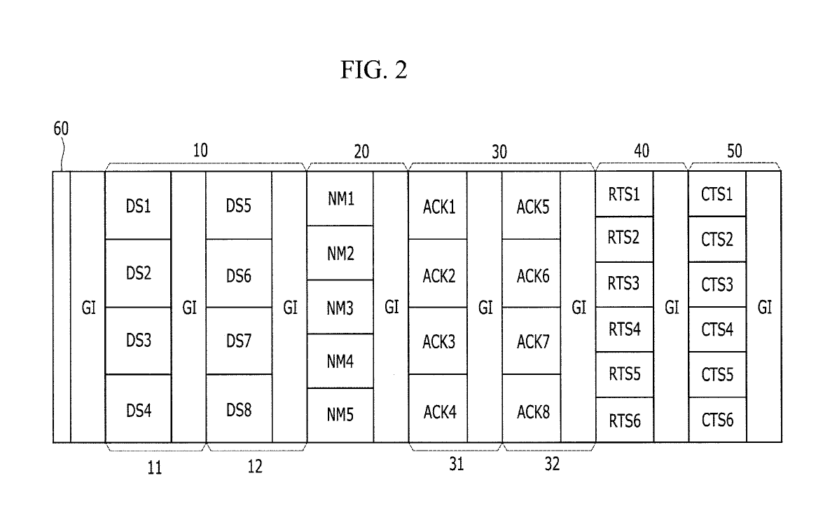

The nodes N1 to N9 refer to devices, namely, communication nodes, which employ a method of sharing and managing the same radio communication resources with neighbor communication nodes, without a coordinator for managing radio communication resources shared by the neighboring communication nodes. Namely, the nodes N1 to N9 share communication frames (to be described with reference to FIG. 2) with neighbor nodes.

The nodes N1 to N9 may be transmission nodes that generate and transmit data, or may be reception nodes that receive data transmitted by transmission nodes.

FIG. 2 is a view illustrating a communication frame used for communication between nodes according to an exemplary embodiment of the present invention.

In FIG. 2, a horizontal axis is a time length of a communication frame defined on a time axis, the time length of the communication frame is fixed, and the communication frame is continuously repeated. A vertical axis refers to frequency channels and may include one or more frequency channels.

With reference to FIG. 2, the communication frame includes a data area 10, a uni-directional transmission area 20, an acknowledgement area 30, a request-to-send (RTS) area 40, and a clear-to-send (CTS) area 50.

The data area 10 includes at least one sub-areas 11 and 12, and the sub-areas 11 and 12 include at least one data slot DS1 to DS4 and DS5 to DS8, respectively. The data slots DS1 to DS8 correspond to at least one unit time slot defined on frequency.

The acknowledgement area 30 includes at least one sub-areas 31 and 32, and the sub-areas 31 and 32 include at least one acknowledgement slot ACK1 to ACK4 and ACK5 to ACK8, respectively. The acknowledgement slots ACK1 to ACK4 and ACK5 to ACK8 correspond to at least one unit time slot defined on frequency. The acknowledgement slots ACK1 to ACK8 are matched to the data slots DS1 to -DS8 in a one-to-one manner.

For example, when the acknowledgement slots ACK1 to ACK8 are matched to the data slots DS1 to DS8 in order, a transmission side may transmit data to a reception side through the data slot DS2 and receive and check the acknowledgement slot ACK2 corresponding to the data slot DS2, thus confirming the results of the data transmission. Also, the reception side receives and checks a data slot destined for the reception side, and delivers reception results to the transmission side through an acknowledgement corresponding to the data slot.

The RTS area 40 includes at least one RTS slots RTS1 to RTS6, and the CTS area 50 includes at least one CTS slots CTS1 to CTS6. The CTS slots CTS1 to CTS6 are matched to the RTS slots RTS1 to RTS6 in a one-to-one manner. The RTS slots RTS1 to RTS6 and the CTS slots CTS1 to CTS6 correspond to at least one unit time slot defined on frequency, respectively.

For example, in case in which the RTS slots RTS1 to RTS6 are matched to the CTS slots CTS1 to CTS6 in order, when a data slot is desired to be reserved, the transmission side makes a reservation request to the reception side through the RTS slot RTS2. Upon receiving the RTS slot RTS2, the reception side transmits a reservation response to the reservation request through the RTS slot CTS2. Then, the transmission side receives and checks the CTS slot CTS2 and reserves a data slot according to the reservation response after the current communication frame.

The uni-directional transmission area 20 includes at least one uni-directional transmission slots NM1 to NM5. The uni-directional transmission area 20 does not require an acknowledgement from the reception side, and is used for a multicast or unicast transmission. The uni-directional transmission slots NM1 to NM5 also correspond to at least one unit time slot defined on frequency.

The communication frame may include a preamble 60 or certain mutually different signal patterns in a start interval of each of the sub-areas 11, 12, 31, and 32, the uni-directional transmission area 20, the acknowledgement area 30, the RTS area 40, and the CTS area 50, in order to indicate the start of the corresponding areas.

Also, the communication frame may include a guard interval (GI) ahead of or behind the sub-areas 11, 12, 31, and 32, the uni-directional transmission area 20, the acknowledgement area 30, the RTS area 40, and the CTS area 50, in order to protect the slots.

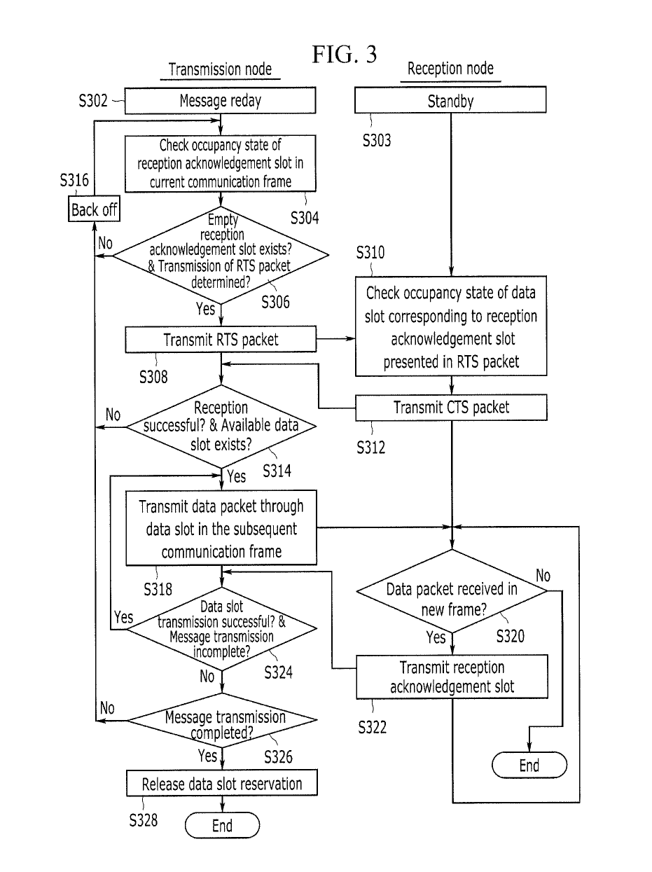

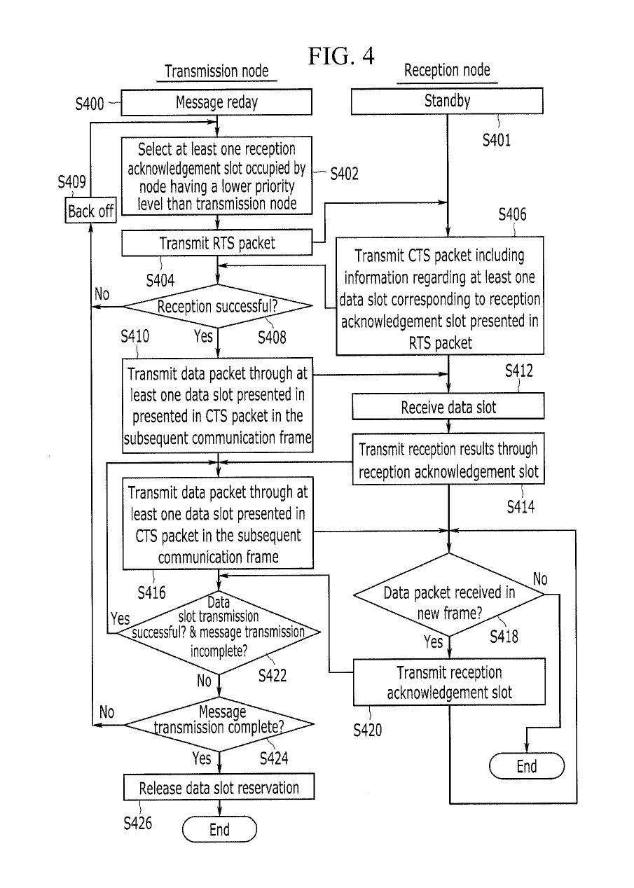

A communication method between nodes by using a communication frame will now be described in detail with reference to FIGS. 3 and 4.

FIG. 3 is a flowchart illustrating the process of a method for transmitting and receiving messages between nodes according to a first exemplary embodiment of the present invention.

With reference to FIG. 3, when the transmission node is ready to transmit a message in operation S302, it changes a single message into one or more packets. The transmission node checks an occupancy state of acknowledgement slots existing in a reception available area of a current communication frame to check whether are one or more empty acknowledgement slots, which are not used by a neighbor node in operation S304.

When there are empty acknowledgement slots not used by a neighbor node and the transmission node determines to transmit a reservation request (Request To Send: RTS) packet in the current communication frame in operation S306, the transmission node selects at least one of the empty acknowledgement slots in order to reserve it, includes information regarding the selected acknowledgement slot and the address of a reception node in the RTS packet, transmits the RTS packet to the reception node through a RTS slot randomly selected in the current communication frame in operation S308, and then receives a reservation response (Clear To Send: CTS) packet from the reception node through a CTS slot corresponding to the transmitted RTS slot.

Namely, when there is an RTS packet destined for the reception node, waiting for receiving an RTS packet, in operation S303, the reception node analyzes the RTS packet to check information regarding acknowledgement slots and check an occupancy state of a data slot corresponding to the information regarding the acknowledgement slots in operation S310. When at least one data slot, which is not occupied by a neighbor node and available for reception, exists, the reception node selects at least one reservation data slot, includes information regarding the reservation data slot, namely, data slot reservation information, in a CT packet, and transmits the CTS packet to the transmission node through a CTS slot in operation S312.

The transmission node may additionally include information regarding the number of data slots to be used for the RTS packet. In this case, the reception node may include data slot reservation information items which are equal to or smaller than the number of additionally included data slots in a non-occupied state among data slots corresponding to non-occupied acknowledgement slots presented in the reservation request information.

When the CTS packet is not successfully received in operation S314 or when the RTS packet fails to be transmitted in the current communication frame in operation S306, the reception node re-attempts the message transmission procedure after the lapse of a certain time (back off) in operation S316.

Meanwhile, when the transmission node successfully receives the CTS packet and there is an available data slot in the data slot reservation information included in the CTS packet in operation S314, the transmission node transmits a data packet through a reservation data slot of a subsequent new frame in operation S318, receives an acknowledgement slot corresponding to the data slot, and checks whether the data has been successfully transmitted. Namely, when the reception node successfully receives a data packet destined for the reception node through a data slot in a new communication frame in operation S320, the reception node transmits an acknowledgement slot corresponding to the data slot to the transmission node in operation S322.

The transmission node confirms that the data slot has been successfully transmitted through the acknowledgement slot, and when a transmission of an additional data packet is required in operation S324, the transmission node transmits the additional data packet by using a data slot at the same position in the next subsequent communication frame, receives an acknowledgement slot corresponding to the data slot, and checks whether or not the data has been successfully transmitted. The transmission node repeatedly performs this process to continuously transmit additional data packets in operations S318 to S322. In this case, the transmission node may determine a maximum number of communication frames to continue the transmission of additional data.

Meanwhile, when the transmission node fails to receive the acknowledgement slot, it may restart the message transmission procedure from the beginning after the lapse of a certain time (back off).

When the transmission of a single complete message is finished through this operation S326, the transmission node terminates the message transmission procedure and release the reservation of the corresponding data slot in operation S328.

In this manner, with the communication method between nodes according to an exemplary embodiment of the present invention, independent links can be maintained between neighbor nodes by using a single radio channel, namely, a communication frame, so equality or fairness in sharing resources can be enhanced.

Also, as described above, with the communication method between nodes according to an exemplary embodiment of the present invention, when there is additional data transmission after the transmission node reserves a data slot, the transmission node can continuously use the reserved data slot. Thus, a real time service can be provided, and even when a traffic load is high, stable communication performance can be guaranteed.

FIG. 4 is a flowchart illustrating the process of a method for transmitting a message by a node according to a second exemplary embodiment of the present invention.

With reference to FIG. 4, in a state in which the transmission node is ready to transmit a message in operation S400, when the transmission node and the reception node exchange a RTS packet and a CTS packet, the transmission node selects at least one of acknowledgement slots used by a transmission node having a lower priority level than that of the transmission node, among neighbor transmission nodes using the acknowledgement slots in a previously communication frame, without checking an occupancy state of the acknowledgement slots in operation S402.

The transmission node includes information regarding the selected at least one acknowledgement slot in an RTS packet, and transmits the RTS packet to the reception node through a RTS slot in operation S404. In this case, the transmission node may mark a flat, which denotes priority, on the RTS packet, and transmit the RTS packet. When the reception node, waiting for receiving an RTS packet, receives the RTS packet denoting priority in operation S401, the reception node includes information regarding at least one data, slot among data slots corresponding to the information regarding the acknowledgement slots, in a CTS packet, and transmits the CTS packet to the transmission node through a CTS slot in operation S406.

When the transmission node successfully receives the CTS packet through the CTS slot in operation S408, it transmits a data packet to the reception node through at least one data slot presented in the CTS packet in the subsequent communication frame in operation S410.

If the transmission node fails to receive the CTS packet, it re-attempts the message transmission procedure after the lapse of a certain time (back off) in operation S409.

When the reception node receives a data packet destined for the reception node through a data slot in operation S412, it transmits data reception results to the transmission node through a acknowledgement slot corresponding to the data slot in operation S414.

In this case, the transmission node may transmit the data packet to the reception node through the data slot extending up to a next frame, namely, through the data slot corresponding to two frames, regardless of a reception state of the acknowledgement slot with respect to the data packet in operation S416.

Namely, unlike the first exemplary embodiment, in the second exemplary embodiment, the RTS packet and the CTS packet are not normally exchanged, having the possibility in which the corresponding data slot is occupied by a neighbor node, so the data packet transmitted in operation S410 is highly likely to be lost due to a collision. Thus, in order to avoid this problem, the transmission node may perform the process of transmitting a data packet to the reception node one more time in operation S416, to thereby allow the reception node to receive the data packet. In this case, a certain data packet may be transmitted in operation S410.

When the reception node successfully receives the data packet destined for the reception node through the data slot in the new communication frame in operation S418, it transmits an acknowledgement slot corresponding to the data slot to the transmission node in operation S420.

The successful transmission of the data slot is confirmed through the acknowledgement slot, and when an additional data packet needs to be transmitted in operation S422, the transmission node transmits the additional data packet by using a data slot at the same position of the next subsequent communication frame, receives an acknowledgement slot corresponding to the data slot, and checks whether or not the data has been successfully transmitted. The transmission node repeatedly performs this process to continuously transmit additional data packets in operations S416 to S420. In this case, the transmission node may determine a maximum number of communication frames to continue the transmission of additional data.

Meanwhile, when the transmission node fails to receive the acknowledgement slot, it may restart the message transmission procedure from the beginning after the lapse of a certain time (back off).

When the transmission of a single complete message is finished through this operation S424, the transmission node terminates the message transmission procedure and release the reservation of the corresponding data slot in operation S426.

In this manner, the transmission node according to the second exemplary embodiment of the present invention can secure the authority to use a data slot for transmitting a data packet without having to exchange the RTS packet and the CTS packet as in the first exemplary embodiment of the present invention. In this case, the transmission node can transmit an additional data packet by using a corresponding data slot of a next communication frame, regardless of the reception results of the acknowledgement slot corresponding to the data slot which has transmitted the data packet.

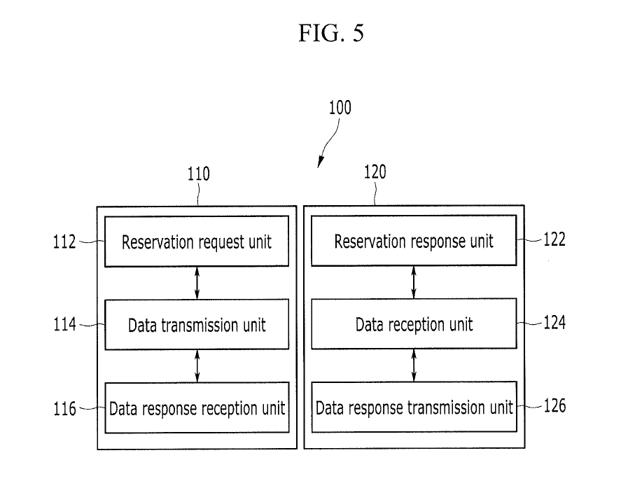

FIG. 5 is a schematic block diagram of a communication apparatus of a node according to an exemplary embodiment of the present invention.

With reference to FIG. 5, each of the nodes N1 to N9 includes a communication apparatus 100 communicating with neighbor nodes.

The communication apparatus 100 includes a transmission processing unit 110 and a reception processing unit 120.

The transmission processing unit 110 includes a reservation request unit 112, a data transmission unit 114, and a data response reception unit 116, and the reception processing unit 120 includes a reservation response unit 122, a data reception unit 124, and a data response transmission unit 126.

Here, the transmission processing unit 110 performs the operations described above with reference with FIG. 3.

In detail, in the transmission processing unit 110, the reservation request unit 112 determines a reservation data slot for transmitting a message. In detail, when a message is generated to be in a transmission standby state, the reservation request unit 112 checks an occupancy state of acknowledgement slots in an acknowledgement area of a current communication frame and selects at least one empty acknowledgement slot which is not used by a neighbor node. The reservation request unit 112 includes information regarding the selected acknowledgement slot and the address of a reception node in an RTS packet and transmits the RTS packet through a RTS slot selected by the RTS area 40, and thereafter, the reservation request unit 112 receives a CTS packet through a CTS slot corresponding to the RTS slot and checks a reservation data slot. In this manner, when the reservation data slot is determined, the reservation request unit 112 delivers information regarding the reservation data slot to the data transmission unit 114.

Meanwhile, the reservation request unit 112 may include information regarding an acknowledgement slot of a neighbor transmission node having a lower priority level than that of the communication apparatus 100 in an RTS packet and transmit the RTS packet through the method illustrated in FIG. 4, rather than checking the occupancy state of the acknowledgement slots. In this case, the reservation request unit 112 marks a flag, which denotes priority, on the RTS packet.

The data transmission unit 114 transmits a data packet through the reservation data slot.

The response data reception unit 116 checks whether the data has been successfully transmitted through the acknowledgement slot corresponding to the reservation data slot. Namely, the response data reception unit 116 checks whether a reception node has successfully received through the acknowledgement slot corresponding to the reservation data slot, and delivers the corresponding results to the data transmission unit 114.

The data transmission unit 114 retransmits the data packet or transmits an additional data packet according to the results provided from the response data reception unit 116.

In the reception processing unit 120, the reservation response unit 122 receives every available RTS slots in the communication frame, checks corresponding data slots from the information regarding the acknowledgement slots included in the RTS packet destined for the communication apparatus 100, selects at least one empty, receivable reservation data slot, includes information regarding the selected reservation data slot in a CTS packet, and transmits the CTS packet through a CTS slot corresponding to the RTS slot.

Meanwhile, when the reservation response unit 122 receives the RTS packet denoting priority, the reservation response unit 122 may include the information regarding the data slot corresponding to the acknowledgement slot, which is included in the RTS packet, in the CTS packet through the method illustrated in FIG. 4, rather than checking the occupancy state of the data slots, and transmit the CTS packet.

The information regarding the reservation data slot may be transmitted through a CTS slot.

The data reception unit 124 receives the data packet destined for the communication apparatus 100 through the reservation data slot.

The data response transmission unit 126 transmits the data reception results through an acknowledgement slot corresponding to the reservation data slot.

According to an exemplary embodiment of the present invention, when there is additional data transmission after the transmission node reserves a data slot, the transmission node can continuously use the reserved data slot. Thus, a real time service can be provided, and even when a traffic load is high, stable communication performance can be guaranteed.

Also, according to an exemplary embodiment of the present invention, independent links can be maintained between neighbor nodes by using a single radio channel, namely, a communication frame, so equality or fairness in sharing resources can be enhanced.

The exemplary embodiments of the present invention as described so far are not implemented only through a device or a method but may be implemented through a program that can realize a function corresponding to the configuration of the exemplary embodiments of the present invention or a recording medium storing the program, and such implementations may be easily made by a skilled person in the art to which the present invention pertains from the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication method for transmitting a message by a transmission node to a reception node in a wireless communication system in which communication nodes share the same frame structure and frame synchronization.
transmitting information regarding an occupancy state of an acknowledgement slot of the current communication frame to the reception node through a request-to-send (RTS) slot;
receiving information regarding an occupancy state of a data slot corresponding to the acknowledgement slot from the reception node through a clear-to-send (CTS) slot corresponding to the RTS slot;
when there is information regarding an available data slot upon receiving the CTS slot, securing the authority to use a data slot at a position corresponding to the information regarding the available data slot in the subsequent communication frame;
transmitting a data packet to the reception node through the data slot secured to be used; and
receiving an acknowledgement slot corresponding to the data slot from the reception node to confirming whether the data packet has been received.

2. The method of claim 1, wherein the transmitting of the RTS slot to the reception node comprises:
including information regarding at least one of acknowledgement slots of a transmission node having a lower priority level than that of the transmission node in the current communication frame, in a RTS packet;
marking a flag, which denotes priority, on the RTS packet; and
transmitting the RTS packet to the reception node through the RTS slot.

3. The method of claim 2, wherein the receiving of the CTS slot comprises:
transmitting a CTS packet through the CTS slot,
wherein when the RTS packet includes a flag, which denotes priority, marked thereon, the CTS packet includes information regarding a data slot corresponding to the acknowledgement slot presented in the received RTS packet in the CTS packet.

4. The method of claim 1, further comprising:
when it is confirmed that transmission of the data slot, for which the authority to use is secured, is successfully completed upon receiving the acknowledgement slot, securing the authority to use a data slot at the same position corresponding to the information regarding the available data slot in the next subsequent frame;
transmitting an additional data packet to the reception node through the data slot secured to be used in the next subsequent frame; and
receiving the acknowledgement slot corresponding to the data slot from the reception node to confirm whether the additional data packet has been received.

5. The method of claim 4, wherein, in the transmission of the additional data packet, the additional data packet is transmitted through the data slot secured to be used up to the number of times corresponding to a determined number of continuous communication frames.

6. The method of claim 1, wherein the transmission of the information regarding an occupancy state of an acknowledgement slot to the reception node through the RTS slot comprises:
checking an occupancy state of a plurality of acknowledgement slots in the current communication frame and selecting at least one empty acknowledgement slot; and
transmitting information regarding the at least one empty acknowledgement slot through the RTS slot.

7. The method of claim 6, wherein the transmitting of the information regarding an occupancy state of a reception acknowledgement slot to the reception node through the reservation request slot comprises:
transmitting information regarding the number of data slots to be secured for authority to use the data slots through the RTS slot.

8. The method of claim 6, wherein the transmitting of the information regarding at least one empty acknowledgement slot through the RTS slot comprises:
including information regarding the at least one empty acknowledgement slot in a RTS packet and transmitting the same through the RTS slot.

9. The method of claim 6, wherein the reception of information regarding an occupancy state of a data slot corresponding to the reception acknowledgement slot from the reception node through a reservation response slot corresponding to the reservation request slot comprises:
receiving information regarding at least one empty data slot in the current communication frame, among data slots corresponding to the at least one empty acknowledgement slot, through the CTS slot.

10. The method of claim 8, wherein the reception of the information regarding the at least one data slot through the CTS slot comprises:
receiving a CTS packet including the information regarding the at least one data slot through the CTS slot.

11. The method of claim 1, wherein the communication frame comprises at least one uni-directional transmission slot, and the method further comprising:
transmitting a uni-directional data packet, which does not request a response, through the uni-directional transmission slot.

12. A communication method for receiving a data message by a reception node from a transmission node in a wireless communication system in which communication nodes share the same frame structure and frame synchronization, the method comprising:
Receiving, from the transmission node, information regarding an occupancy state of an acknowledgement slot of the transmission node through a request-to-send (RTS) slot in the current communication frame;
transmitting information regarding an occupancy state of the data slot corresponding to an unoccupied acknowledgement slot from the information regarding the occupancy state of the acknowledgement slot to the transmission node through a clear-to-send (CTS) slot;
receiving the data slot at the corresponding position with reference to the position of an unoccupied data slot in the subsequent frame; and
transmitting reception results of the data slot to the transmission node through an acknowledgement slot corresponding to the received data slot.

13. The method of claim 12, wherein the receiving of the information regarding an occupancy state of a reception acknowledge slot through the RTS slot comprises:
receiving a RTS packet with a flag, which denotes priority, marked thereon,
wherein the RTS packet comprises information regarding at least one of acknowledgement slots of a transmission node having a lower priority level than that of the transmission node in the current communication frame.

14. The method of claim 13, wherein the transmitting of the information regarding an occupancy state of the data slot through the CTS slot comprises:
when a flag, which denotes priority, is marked on a received RTS packet, including information regarding a data slot corresponding to an acknowledgement slot presented in the received RTS packet, in a CTS packet; and
transmitting the CTS packet through the CTS slot.

15. The method of claim 12, wherein the receiving of the information regarding an occupancy state of an acknowledgement slot through the RTS slot comprises:
receiving information regarding at least one empty acknowledgement slot among a plurality of acknowledgement slots in the current communication frame through the RTS slot.

16. The method of claim 15, wherein the transmitting of information regarding an occupancy state of a data slot through the CTS slot comprises:
transmitting information regarding at least one empty data slot in the current communication frame, among data slots corresponding to the at least one empty acknowledgement slot, through the CTS slot.
